(19) United States
(12) Patent Application Publication
(10) Pub. No.: US 2004/0178346 A1
(43) Pub. Date: Sep. 16, 2004

(54) OIL WELL LOGGING SENSOR

(76) Inventors: James R. Williams, University Heights, OH (US); Jeffrey Louis Johanning, Hudson, OH (US)

Correspondence Address: NIXON & VANDERHYE P.C./G.E., 1100 N. GLEBE RD., SUITE 800, ARLINGTON, VA, 22201, US

(21) Appl. No.: 10/249,045

(22) Filed: Mar. 12, 2003

(51) Int. Cl. G01T 1/20

(52) U.S. Cl. 250/363.01

(57) ABSTRACT

A scintillator for a radiation detector includes a substantially cylindrical scintillating element mounted in a substantially cylindrical housing; and a gamma ray source substantially enclosed within the scintillating element.

### BACKGROUND OF INVENTION

This invention relates to devices for detecting radiation in oil well logging and, specifically, to a scintillation crystal that incorporates an internal gamma ray source.

One method of oil well logging, known as density logging, employs a gamma ray source in the logging tool. Gamma radiation from this source is scattered by the well-bore environment, producing gamma rays of lesser energy. These gamma rays are detected by a scintillation (or radiation) detector (typically, an Nal crystal element coupled to a photo-multiplier tube) in the tool, and provide information on physical traits, primarily the density, of the well-bore environment. Nal used in oil-well logging applications must be encapsulated in a hermetic seal. Furthermore, the housing of the crystal must be rugged enough to survive the extreme temperature and vibration encountered in well drilling. It is useful in this type of logging to place a small calibration source in close proximity to the scintillator in order to continuously calibrate the detector. The only known technique for including a source in the scintillator under these circumstances is to put the source outside the scintillator, either inside or outside the hermetic seal. This approach, however, causes backscattered gamma rays of undesirable energy to be detected. Also, the geometry is unfavorable because there are many possible gamma ray paths that do not penetrate the scintillator far enough to have a high likelihood of being completely absorbed, but do have appreciable probability for being Compton scattered. These backscattered and partially absorbed gamma rays, known as Compton scattered events, interfere with the gamma rays scattered off the well-bore environment because they appear in the same energy range. Therefore, this part of the spectrum due to Compton scattering must be subtracted out. This results in a large uncertainty in the desired measurement. Accordingly, there is a need for minimizing Compton scatter events while maintaining the required counting rate for the calibration peak so that the accuracy of the measurement can be optimized.

### SUMMARY OF INVENTION

In the exemplary embodiment, the scintillation or radiation detector, includes an Nal crystal of generally cylindrical shape that is hermetically sealed within a titanium or stainless steel housing. The crystal or scintillator is engaged with a photomultiplier tube, and an optical window is located axially between these components so that light from the scintillator is transmitted into the photo-multiplier tube.

Both backscattering and geometry difficulties can be minimized by placing the radioactive (or gamma ray) source within the bulk of the scintillator. By so placing the source, all gamma rays must pass through the scintillator before having the opportunity to backscatter off the ruggedizing components located radially outward from the scintillator. Likewise, all possible gamma ray paths require passage through a significant amount of the scintillator material. In this way, the peak-to-Compton ratio can be maximized, with the precise peak counting rate controlled by the activity level of the included source. Negative effects on the light collection from the scintillator can be offset by making the source reflective.

In the preferred embodiment, a blind bore just larger than the gamma ray source is drilled into the scintillator (or crystal) along its axis, the scintillator being axially symmetric, to a depth of approximately one-half the length of the scintillator. The source is placed into a mold approximately the same size as the hole bored into the scintillator. The mold is then filled with a reflective elastomer, which is then cured, forming a reflective sleeve around the source. The elastomeric plug, containing the source and reflective sleeve, is then inserted into the crystal, which is then prepared according to the usual methods, as further described below. In the exemplary embodiment, the mold is shaped to produce a sleeve with circumferentially spaced lobes that facilitate insertion into the crystal. Space between the lobes is subsequently backfilled with a similar elastomer.

Reflectivity of the gamma ray source can also be achieved by painting the source, or by dropping the source into a cavity suitably prepared with a reflective internal surface.

In the exemplary embodiment, the blind bore is aligned with the center axis of the scintillator. Alternatively, the source can be imbedded in the scintillator through an off-axis entry, or the source can be sandwiched between two scintillators, which are then glued together. After insertion of the gamma ray source, the scintillator component of the detector is wrapped with reflective tape. Surrounding the tape is a polyamide wrap, and a sidewall axial restraint and compliance assembly (SARCA) similar to that disclosed in, for example, U.S. Pat. No. 5,962,855. The SARCA generally includes inner and outer layers of material. The outer layer of the SARCA may be a Teflon® coated stainless steel sleeve and the inner layer may be a sleeve. The Teflon® coated stainless steel sleeve is arranged with the Teflon® coated side to the outside of the detector. The assembled SARCA is held in place about the scintillator or crystal by, for example, a strip of Kapton tape.

The scintillator assembly is then located within a cylindrical titanium or stainless steel shield or housing, with axially extending leaf springs spaced about the scintillator assembly, radially between the scintillator assembly and the shield. One end of the shield is closed by a compression plate, axial spring and end cap, while the other end is provided with a window and an optical coupler. The shield is thereafter secured to the photo-multiplier tube (PMT), with the window or optical coupler axially sandwiched between the scintillator and the PMT.

Accordingly, in one aspect, the invention relates to a scintillator for a radiation detector comprising a substantially cylindrical crystal element mounted in a substantially cylindrical housing; and a gamma ray source substantially enclosed by the crystal element.

In another aspect, the invention relates to a scintillator assembly comprising a substantially cylindrical crystal element mounted in a substantially cylindrical housing; a radial and axial support assembly within the housing, located radially between the crystal element and the housing, the crystal element enclosing a gamma ray source.

In still another aspect, the invention relates to a scintillator for a well logging gamma ray detector tool comprising a cylindrical scintillator body having a bore formed therein; and a gamma ray source component enclosed within the scintillator body.

The invention will now be described in greater detail with reference to the accompanying drawings.

### BRIEF DESCRIPTION OF DRAWINGS

FIG. 1 is an exploded view of a radiation detector incorporating a scintillator in accordance with this invention;

FIG. 2 is a cross-sectional view of the scintillator in accordance with the invention, prior to insertion of the gamma ray source;

FIG. 3 is a perspective view of an encapsulated gamma ray source for insertion into the scintillator shown in FIG. 2;

FIG. 4 is a cross-section taken along the line 4-4 of FIG. 3; and

FIG. 5 is a cross-section taken along the line S-S of FIG. 4.

### DETAILED DESCRIPTION

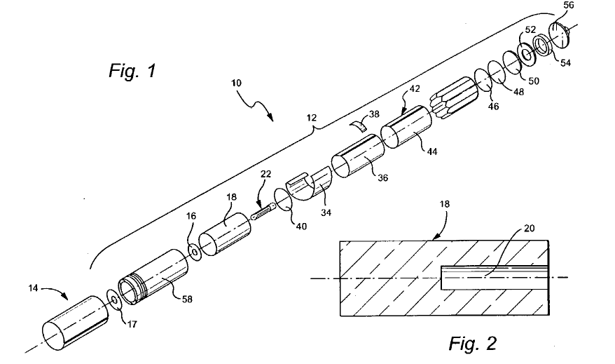

Referring initially to FIG. 1, a scintillation or radiation detector 10 for use in, for example, a well logging tool, generally includes a scintillator assembly 12 and a photomultiplier tube (or PMT) 14 adapted to be coupled together in axial alignment, with optical couplers or windows 16, 17 located therebetween. This is a conventional arrangement that is well known in the art. The specific arrangement shown in FIG. 1 is for illustrative purposes only, and will be further described below. This invention here relates to the scintillator 18 and the incorporation of a gamma ray source 22 therein. With reference now to FIG. 2, the scintillator 18 is a machined cylindrical crystal element, preferably a sodium-iodide (Nal) crystal. Other suitable compositions for the crystal element include anthracene, bismuth germanium oxide (BGO, cerium oxide (Cel), cesium iodide (Csl), gadolinium orthosilicate (GSO), lutetium orthosilicate (LSO) and other like substances. The scintillator or crystal 18 receives radiation from the well bore, transforms the radiation into light impulses and transmits the light impulses into the photo-multiplier tube 14.

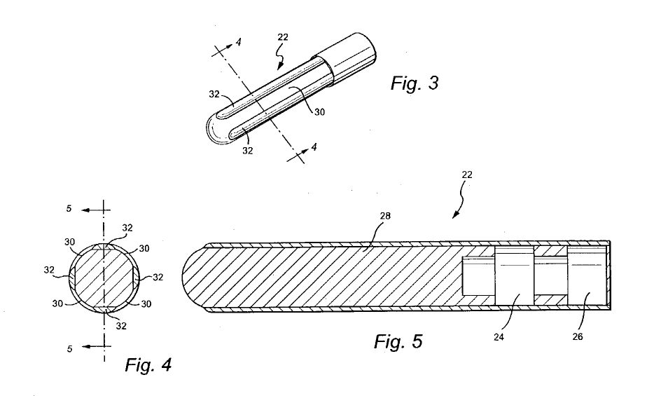

The scintillator or crystal 18, in accordance with an exemplary embodiment of this invention, may have a length of about two inches, and provided with a blind bore 20 at one end thereof, along the center axis of the crystal. The bore 20 may be drilled to a depth approximately one-half the length of the crystal (or about one inch) and is adapted to receive a gamma ray source 22. As best seen in FIG. 5, the gamma ray source 22 may comprise a pair of commercially available back-to-back cesium plugs 24, 26. These plugs are placed into a mold (not shown) of generally the same size as the blind bore 22 in the crystal. The mold is filled with a reflective elastomeric material (e.g., Sylgard) which is then cured. This forms a reflective elastomeric sleeve 28, fully encapsulating the gamma ray source. The sleeve 28 with the encapsulated plugs 24, 26 is then inserted into the blind bore 20. In the exemplary embodiment, the mold is configured to provide a non-round shape as best seen in FIGS. 3 and 4. Specifically, the mold is shaped to create four elongated ribs or lobes 32 along a major length portion of the reflective sleeve. These lobes thereby create corresponding elongated grooves or spaces 30 between the lobes at 90 intervals about the periphery of the sleeve. It will be appreciated that by reducing the surface area of the sleeve that engages the ID of bore 20 during insertion, compressive friction will be reduced and the insertion facilitated. After insertion, the remaining space between the sleeve and the ID of the bore, i.e., in the area of spaces 30, is backfilled with a similar elastomeric material that also closes the open end of the bore 20 such that the plugs 24, 26 are fully encapsulated within the sleeve 28. It will be appreciated that other insert configurations are within the scope of this invention. For example, the number and arrangement of plugs 24, 26 may be varied, along with the diameter and length dimensions of the sleeve 28. The mold configuration may also be varied to provide other sleeve shapes that facilitate insertion into the bore in the crystal element. It will also be appreciated that the bore 20 may be drilled as a through bore, and backfilled at both ends after insertion of the gamma ray source.

It will be further understood that the gamma ray source 22 may be enclosed in the scintillator 18 by an off-axis bore, or sandwiched between a pair of scintillators that are subsequently glued together. Other suitable arrangements by which the gamma ray source 22 is enclosed or encapsulated within the scintillator are within the scope of this invention. For example, rather than encapsulating the source 22 in a reflective elastomeric sleeve, the plugs 24, 26 and/or sleeve 28 could be painted with reflective material, or the blind bore 20 could be lined with reflective material.

With reference again to FIG. 1, the scintillator or crystal 18 may be wrapped a reflective Teflon® tape 34. A thin polyamide layer 36 may then be wrapped about the cylindrical portion of the crystal 18 and secured by a ¼″ strip of Kapton tape 38. A reflective disk 40 may be arranged on the back face of the scintillator. The SARCA assembly 42 may include an outer stainless steel sleeve 44, the outer surface of which is coated with Teflon®, and an inner polyamide sleeve. Details of the SARCA may be found in U.S. Pat. No. 5,962,855.

The final assembly in accordance with one exemplary embodiment includes locating the optical coupler 16 at the forward end of the scintillator crystal 18, preferably with silicon oil between the coupler and the front face of the crystal. At the opposite or rearward end of the crystal, additional reflector discs 46, 48 and 50 may be located adjacent disk 40, along with a compression plate 52, axial spring 54 and an end cap 56. This assembly is then located within a titanium or stainless steel shield 58, with an array of axially extending radial springs 60 located between the assembly 12 and the shield 58. The end cap 56 is welded to one end of the shield 58, thereby holding all of the above components within the shield. The forward end of the shield 58 is threaded to facilitate attachment to the photo-multiplier tube 14 in conventional fashion, and the detector may then be located in an oil well logging tool housing (not shown).

After placing the above described detector in an appropriate tool “package,” the peak-to-Compton ratio for a detector of a particular size was determined to be 0.59, which exceeds that which is achievable by the current external irradiation methodology of 0.40 for a detector of the same size.

It will be appreciated that the above described detector assembly is for illustrative purpose only. The crystal 18 incorporating the gamma ray source 22 is not limited to use in the described assembly, but may be used in various other detector configurations.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A scintillator for a radiation detector comprising a substantially cylindrical scintillating element mounted in a substantially cylindrical housing; and a gamma ray source substantially enclosed within said scintillating element.

2. The scintillator of claim 1 wherein said scintillating element is formed with a bore therein and wherein said gamma ray source is received within said bore.

3. The scintillator of claim 2 wherein said bore is a blind bore.

4. The scintillator of claim 1 wherein said gamma ray source comprises one or more cesium plugs carried by a reflective elastomer sleeve.

5. The scintillator of claim 1 wherein said scintillating element is comprised of sodium iodide.

6. The scintillator of claim 1 wherein said bore lies on a longitudinal axis of said scintillating element.

7. A scintillator assembly for a radiation detector comprising a substantially cylindrical scintillating element mounted in a substantially cylindrical housing; a radial and axial support assembly within said housing, located radially between said scintillating element and said housing, said scintillating element enclosing a gamma ray source.

8. The scintillator assembly of claim 7 wherein said gamma ray source is carried by a reflective elastomer sleeve.

9. The scintillator assembly of claim 7 wherein said gamma ray source is received within a blind bore formed in said scintillating element.

10. The scintillator assembly of claim 9 wherein said blind bore has a length approximately one-half a length dimension of said scintillating element.

11. The scintillator assembly of claim 9 said blind bore lies on a longitudinal axis of said scintillating element.

12. A scintillator for a well logging gamma ray detector tool comprising:
a cylindrical sodium-iodide crystal having a bore formed therein; and
a gamma ray source component enclosed within said crystal.

13. The scintillator of claim 12 wherein said bore is aligned with a longitudinal axis of said crystal.

14. The scintillator of claim 13 wherein said bore is a blind bore that extends from one end of said crystal about one-half a length dimension of said crystal.

15. The scintillator of claim 12 wherein said gamma ray source component has a reflective elastomer sleeve molded thereabout, said sleeve received in said bore.

16. An oil well logging sensor comprising a scintillator optically coupled to a photomultiplier tube, said scintillator comprising a cylindrical scintillating element enclosing a gamma ray source therein.

17. The oil well logging sensor of claim 16 wherein said scintillating element is formed with a bore and wherein said gamma ray source is received within said bore.

18. The oil well logging sensor of claim 16 wherein said gamma ray source is carried by a reflective elastomer sleeve.

19. The oil well logging sensor of claim 16 wherein said scintillating element is comprised of sodium iodide.

20. The oil well logging sensor of claim 16 wherein said bore lies on a longitudinal axis of said scintillating element.

21. The oil well logging sensor of claim 16 wherein said gamma ray source comprises one or more cesium plugs carried by a reflective elastomer sleeve.

22. The oil well logging sensor of claim 17 wherein said bore is a blind bore.
